(19) United States
(12) Patent Application Publication
(10) Pub. No.: US 2008/0127351 A1
(43) Pub. Date: May 29, 2008

(54) Method and apparatus for providing and processing contents using D.R.M

(76) Inventors: Jae-Seok Jang, Seoul (KR); Seok-Bin Im, Seoul (KR); Han-Up Bae, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/999,176

(22) Filed: Dec. 3, 2007

Related U.S. Application Data
(63) Continuation of application No. PCT/KR2006/002127, filed on Jun. 2, 2006.

(30) Foreign Application Priority Data
Jun. 3, 2005 (KR) 10-2005-0047786
Jun. 8, 2005 (KR) 10-2005-0048931

(51) Int. Cl. G06F 21/00

(52) U.S. Cl. 726/26

(57) ABSTRACT

A digital rights management (DRM)-based package content providing method is disclosed. In one embodiment, one or more individual contents contained in a content package are first detected in response to a content package purchase order received from a user terminal and a package right object that can be commonly used for all of the detected individual contents is generated. Then, each of the individual contents is encoded and content transmitting information containing the encoded individual contents and the package right object is generated and transmitted to the user terminal.

### CROSS-REFERENCE TO RELATED APPLICATIONS

This application is a continuation application, and claims the benefit under 35 U.S.C. §§ 120 and 365 of PCT Application No. PCT/KR2006/002127, filed on Jun. 2, 2006 and, which is hereby incorporated by reference.

### BACKGROUND OF THE INVENTION

1. Field of the Invention

The present invention relates to a method and apparatus for providing and processing contents using digital rights management (DRM), and more particularly, to a method and apparatus for providing and processing digital contents package or period-based flat rate service digital contents using DRM.

2. Description of the Related Technology

In recent years, with the development of a computer technology and network technology, the digital contents industries have been widely prevalent.

The digital content means immaterial information circulating online, such as an e-book or multimedia (i.e., an image, music, video, a game, and the like). Such digital contents are composed of a program or a data file that is operated by a specific system (i.e., a computer system). Therefore, they can be easily and illegally distributed and copied by Internet or a data storage device (i.e., a compact disk, a floppy disk, and the like). In order to prevent the illegal copy and distribution of the digital contents, the digital contents producers and providers have been making a variety of endeavors.

A user authentication method using DRM technology is well known as a method for preventing the illegal copy and distribution of the digital contents.

### SUMMARY OF CERTAIN INVENTIVE ASPECTS

One aspect of the present invention provides a method and apparatus for providing and processing digital contents of a content package (hereinafter interchangeably used with “package content”) using DRM, wherein a user can conveniently use the digital contents.

Another aspect of the present invention provides a method and apparatus for providing and processing period-based flat rate service digital contents using the DRM, wherein a user can conveniently use the digital contents.

Another aspect of the present invention provides a method and apparatus for providing and processing digital contents using DRM, wherein the change of the right objects due to the expiration of the use of the digital contents of a period-based flat rate service can be effectively achieved.

Another aspect of the present invention provides a method and apparatus that can generally manage right objects of not only packaged digital contents but also period-based flat rate service digital contents using DRM.

Another aspect of the present invention provides a DRM (Digital Rights Management)-based package content providing method including: detecting one or more individual contents contained in a content package in response to a content package purchase order received from a user terminal; generating a package right object that can be commonly used for all of the detected individual contents; encoding each of the individual contents; and generating and transmitting content transmitting information containing the encoded individual contents and the package right object to the user terminal.

Another aspect of the present invention provides a DRM-based package content processing method including: receiving content transmitting information of a content package containing encoded individual contents and a package right object that can be used for all of the individual contents; decoding one of the individual contents contained in the content transmitting information, which is requested to be executed, using the package right object; and executing the decoded individual content.

Another aspect of the present invention provides a DRM-based content providing method including: updating a user management database (DB) in response to a period-based flat rate service subscription request received from a user terminal; generating and providing a master right object allowing a user to use all of the contents for a service period to the user terminal; determining if the user subscribes the period-based flat rate service by searching the user management DB in response to a content use request received from the user terminal; encoding, when it is determined that the user subscribes the period-based flat rate service, a period-based flat rate content requested by the user and an individual right object for the content requested by the user; and transmitting content transmitting information containing the encoded period-based flat rate content and individual right object.

Another aspect of the present invention provides a DRM-based content processing method including: requesting a period-based flat rate service content; receiving content transmitting information containing the requested period-based flat rate service content, which is encoded in response to the requesting of the period-based flat rate service content period-based flat rate content, and an individual right object from a content providing server; decoding the encoded individual right object using a master right object received from the content providing server and stored in advance; and decoding the encoded individual content using the decoded individual right object.

Still another aspect of the present invention provides a DRM based content providing apparatus including: a content management DB unit for storing information on a content package and one or more individual contents contained in the content package; a control unit for detecting the one or more individual contents contained in the content package from the content management DB in response to a content purchase order of the package content received from a user terminal; a right object generation unit for generating a package right object that can be commonly used for the individual contents detected by the control unit; and a content transmitting information generation unit information for encoding the individual contents detected by the control unit, generating content transmitting information of the content package containing the package right object, and transmitting the content transmitting information to the user terminal.

Still another aspect of the present invention provides a DRM-based content processing apparatus including: a communication interface unit for receiving content transmitting information on the package content containing one or more encoded individual contents and a package right object that can be commonly used for all of the individual contents; and one or more encoded individual contents and a content package containing a package right object that can be commonly used for all of the individual contents; a content storing unit for detecting the encoded individual contents from the content transmitting information and storing the detected contents therein; a right object storing unit for detecting the encoded package right object for decoding the encoded individual contents from the content transmitting information and storing the detected right object therein; and a DRM agent for decoding one of the individual contents, which is requested to be executed, contained in the content package.

Yet another aspect of the present invention provides a DRM-based content providing apparatus including: a content management database for storing information on a period-based flat rate service content period-based flat rate contents; a user management database for storing information on users who receive the period-based flat rate service content period-based flat rate contents; a right object generation unit for generating a master right object allowing the user to use all of the contents provided from the server for a predetermined service period in response to subscription request information of the user; and a communication interface unit for transmitting to the user the master right object.

### BRIEF DESCRIPTION OF THE DRAWINGS

FIG. 1 is a schematic view of a contents providing system using DRM.

FIG. 2 is a schematic block diagram of a DRM-based package contents providing server according to an embodiment of the present invention.

FIG. 3 is a view of a database structure for managing individual contents in the content package providing server according to one embodiment of the present invention.

FIG. 4 is a view of a database structure for managing package content in the package content providing server according to one embodiment of the present invention.

FIG. 5 is a view of a database structure for managing contents purchase history information in the package content providing server according to one embodiment of the present invention.

FIG. 6 is a view of a data format for a package content transmitted from the package content providing server according to one embodiment of the present invention to a user terminal.

FIG. 7 is a schematic block diagram of a package content processing terminal according to an embodiment of the present invention.

FIGS. 8 and 9 are views of database structures for managing content information stored in the package content processing terminal according to one embodiment of the present invention.

FIGS. 10 and 11 are views of database structures for managing content information stored in the package content processing terminal according to one embodiment of the present invention.

FIG. 12 is a flowchart of a process for processing the package content in the package content providing server according to an embodiment of the present invention.

FIG. 13 is a flowchart of a process for processing the package content in the package content processing terminal according to an embodiment of the present invention.

FIG. 14 is a schematic block diagram of a DRM-based period-based flat rate service content period-based flat rate contents providing server according to an embodiment of the present invention.

FIG. 15 is a view of a database structure for managing contents in the package content providing server according to the embodiment of FIG. 14.

FIG. 16 is a view of a database structure for managing users in the package content providing server according to one embodiment of the present invention.

FIG. 17 is a view of a database structure for managing period-based flat rate service content period-based flat rate contents information transferred from the content providing server to a user terminal according to another embodiment of the present invention.

FIG. 18 is a view of a database structure for managing master right object information transferred from the content providing server to a user terminal according to another embodiment of the present invention.

FIG. 19 is a flowchart of a DRM-based period-based plan contents providing and processing method according to an embodiment of the present invention.

### DETAILED DESCRIPTION OF CERTAIN INVENTIVE EMBODIMENTS

In the user authentication method using the DRM technology, the user authentication is done by giving digital content and a right object of the digital content to the user and identifying if the right object corresponding to the digital content is available when the user intends to execute the digital content. For example, when specific digital content (first digital content) is provided, the first digital content that is encoded and the right object for decoding the encoded first digital content are simultaneously provided to the user. Then, when the user requests the execution of the first digital content, it is identified if the user has a right object corresponding to the encoded first digital content. When the user has the right object, the encoded first digital content is decoded and executed using the right object. Therefore, even when the digital content to which the DRM technology is applied is illegally copied and distributed, they can be protected as their execution is limited.

However, in the DRM technology, only one right object is assigned per digital content. Therefore, when right objects for one or more digital contents serviced at a specific site (i.e., Music Album) are packaged and given to the user, although the purchase unit is only one, the number of right objects must be identical to that of the digital contents of the digital content package. This increases load of the contents providing server. Furthermore, since the user terminal must store the right objects for the respective digital contents of the content package, the memory efficiency of the user terminal is deteriorated when the number of digital contents of the content package increases.

When the right objects for one or more digital contents serviced at a specific site employing a period-based flat rate service are provided to the user, the number of right objects must be identical to that of the digital contents. Therefore, when the user intends to use all of the digital contents serviced at the specific site with the flat rate service, a large number of right objects are generated.

Furthermore, when the user intends to extend the period, all of the right objects must be changed. That is, after the use of the digital contents of the period-based flat rate service expires, when the user requests the execution of the digital contents, it is determined if the right objects corresponding to the requested digital contents is available and the right objects must be changed.

That is, when the use of the digital contents for the period-based flat rate service expires, all of the right objects corresponding to the digital contents for the period-based flat rate service need to be changed and thus the load of the period-based flat rate service digital contents providing server increases. Furthermore, when the use of the digital contents for the period-based flat rate service expires, it is troublesome for the user to request the change of the right objects for the respective digital contents.

Reference will now be made in detail to embodiments of the present invention, examples of which are illustrated in the accompanying drawings. Wherever possible, the same reference numbers will be used throughout the drawings to refer to the same or like parts. In the following description, when it is determined that the detailed description of the well-known element and functions thereof may muddy the concepts of the present invention, the detailed description thereof will be omitted.

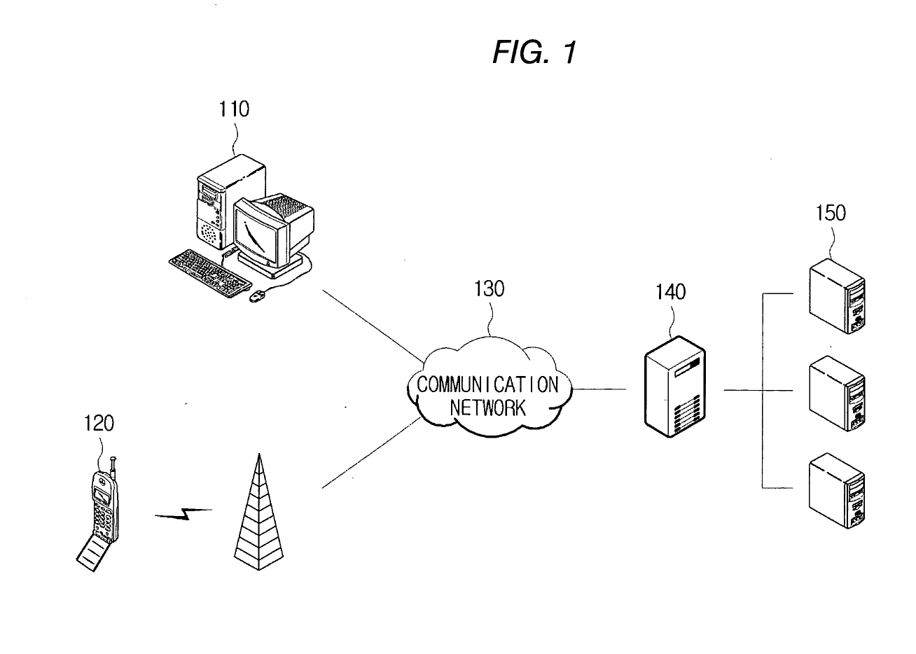

FIG. 1 is a schematic view of a DRM-based contents providing system.

Referring to FIG. 1, a DRM-based contents providing system includes a user terminal system (i.e., a personal computer 110 or a mobile terminal 120) that can be connected to a communication network 130, a contents server 150 storing a variety of contents and providing contents in response to the user's request, and a DRM server 140 encoding the contents provided from the contents server 150 to the user terminal 110 and 120 and generating right objects of the encoded contents.

The DRM server 140 may encode the contents using an encoding method based on “OMA (Open Mobile Alliance) 2.0”. The encoding method based on “OMA 2.0” is one of worldwide standards for encoding the contents, which is well known in the art. Therefore, the detailed description of the encoding method based on the “OMA 2.0” will be omitted herein.

The contents server 150 provides one or more packaged contents and/or period-based flat rate service content period-based flat rate contents. Therefore, the contents server 150 may store the packaged contents and/or the period-based flat rate service content period-based flat rate contents. Meanwhile, the DRM server 140 and the contents server 150 may go by the name of a DRM-based contents providing server. Therefore, the DRM server 140 and the contents server 150 will be called the DRM-based contents providing server hereinafter.

A package content providing apparatus and method according to an embodiment of the present invention will now be described in more detail.

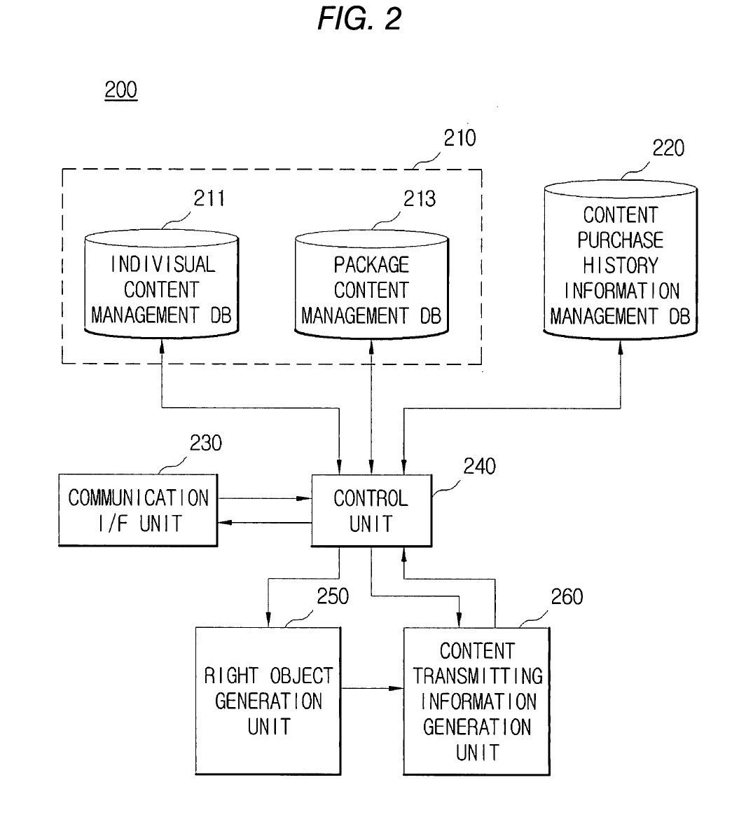

FIG. 2 is a schematic block diagram of a DRM-based package content providing server according to an embodiment of the present invention.

Referring to FIG. 2, a DRM-based package content providing server 200 includes a contents management database (DB) 210, a content purchase history information management DB 220, a communication interface (I/F) unit 230, a control unit 240, a right object generation unit 250, and a content transmitting information generation unit 260.

The contents management DB 210 includes an individual content management DB 211 storing individual contents information and a package content management DB 213 storing package content information. At this point, the individual content is a digital content while the packaged contents are individual contents of the content package.

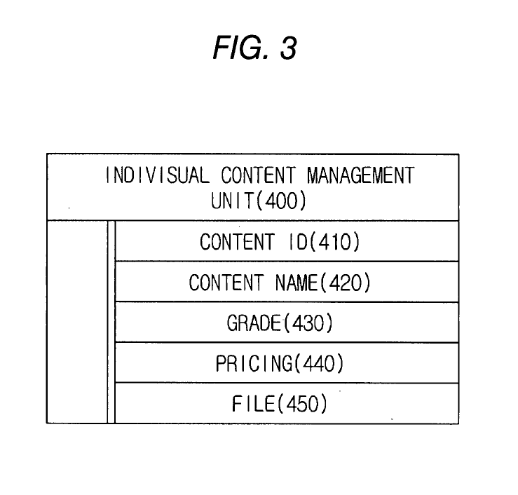

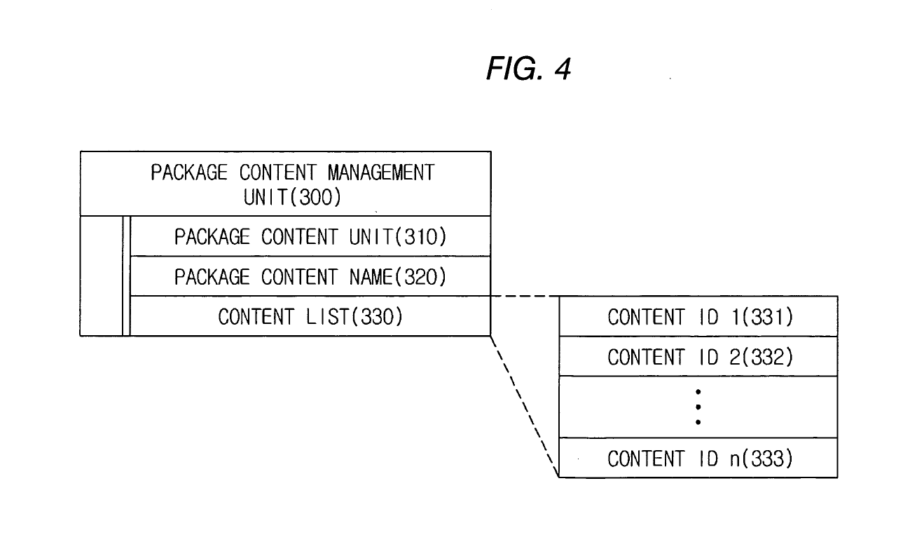

The individual contents management DB 211 stores information on the individual contents assigned with different content identifications (ID). The package management DB 213 stores lists of individual contents of the content package. FIGS. 3 and 4 show DB structures for managing the individual contents and the content package, respectively. Therefore, the DB structures for managing the individual contents and the packaged contents of the package content will be described with reference to FIGS. 3 and 4.

The contents purchase history information management DB 220 stores purchase history information (e.g., a purchase log) of each user.

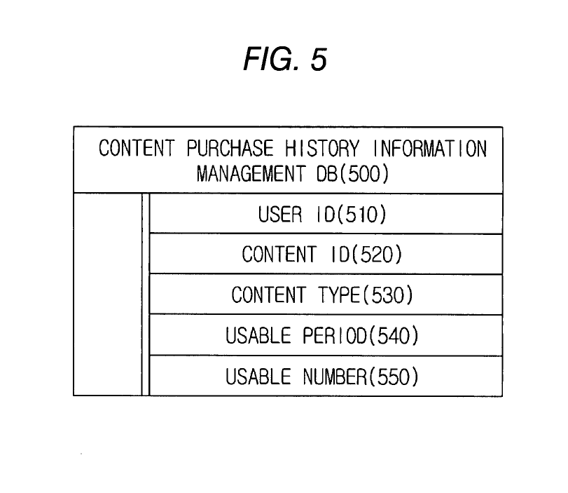

FIG. 5 is a view of a database structure for managing contents purchase history information. Therefore, the DB structure for managing the purchase history information will be described with reference to FIG. 5.

The communication I/F unit 230 provides an interface with the user terminals through the communication network. For example, when the contents purchase order is inputted from the user terminal, the communication I/F unit 230 transmits the order to the control unit 240, receives the package content corresponding to the order from the control unit 240, and transmits the package content to the user terminal.

The control unit 240 searches the individual contents management DB 211 and the package content management DB 213 for contents information corresponding to the user's order information inputted through the communication I/F unit 230 and controls the right object generation unit 250 and the content transmitting information generation unit 260 to generate digital content transmitting information corresponding to the purchase order. For example, when the user orders the content package, the control unit 240 searches the package content management DB 213 for the package content ordered by the user and the individual control management DB 211 for the individual contents contained in the individual contents list with reference to the individual contents list contained in the content package.

The right object generation unit 250 is controlled by the control unit 240 to generate the right objects for the ordered digital contents. For example, when the user orders individual contents, the right object generation unit 250 generates the right objects (individual right objects) corresponding the respective individual contents. When the user orders the content package, the right object generation unit 250 generates a single right object (package right object) representing all of the packaged contents of the package content and transmits the package right object to the content transmitting information generation unit 260.

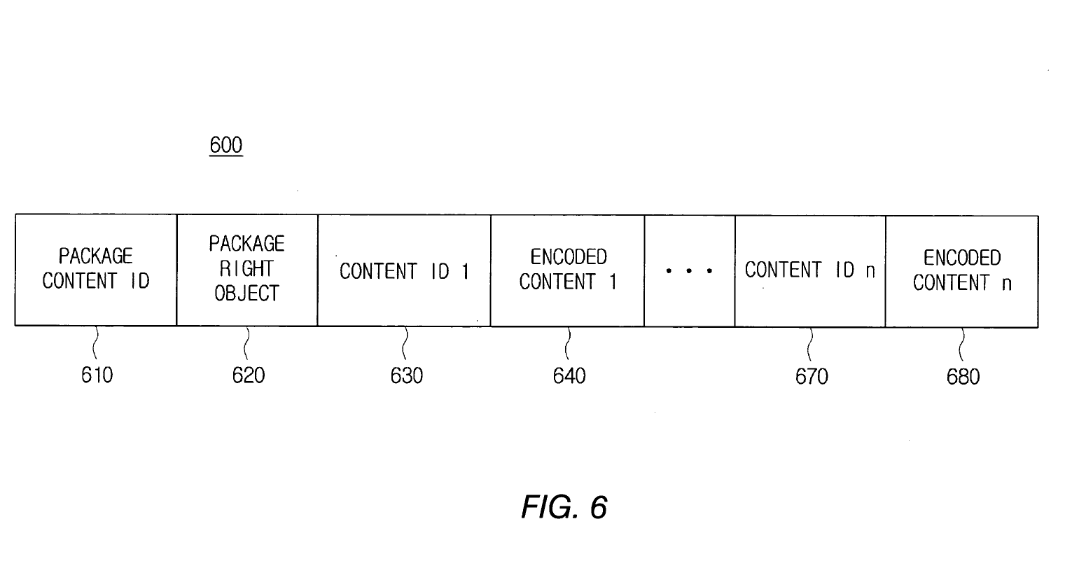

The content transmitting information generation unit 260 receives the content search result through the control unit 240 and the right object for the digital content from the right object generation unit 250 and generates a content transmitting information that will be transmitted to the user terminal. For example, when the user orders an individual content, the contents information generation unit 260 encodes the individual content, receives the right object corresponding to the individual content from the right object generation unit 250, and generates the content transmitting information containing the right object and the encoded individual content. When the user orders the content package, the content transmitting information generation unit 260 receives a digital content search result through the control unit 240 (e.g., one or more individual packaged, contents) and the package right object from the right object generation unit 250. Then, the content transmitting information generation unit 260 encodes one or more packaged individual contents of the package content and generates content transmitting information containing the encoded information and the package right object. An example of the content transmitting information with respect to the packaged individual contents is shown in FIG. 6. Therefore, the content transmitting information for the package content will be described with reference to FIG. 6.

The content transmitting information generation unit 260 transmits the content transmitting information generated above to the user terminal through the control unit 240 and the communication I/F unit 230.

The contents management DB structure of the contents providing server providing the package content as well as a DB structure of a user management DB will now be described with reference to the accompanying drawings.

FIG. 3 shows an example of the DB structure for managing the package content in the package content providing server of FIG. 2.

Referring to FIGS. 2 and 3, the individual contents management DB 200 contained in the package content providing server 200 includes a content ID field 410, a content name field 420, a grade field 430, a pricing field, and a file field 450.

The grade field 430 stores grade information for limiting the users for the specific contents. For example, when it is intended to limit the age of the users for the specific contents under 19, a value “19” is stored in the grade field 430 and when it is intended to limit the age of the users for the specific contents under 15, a value “15” is stored in the grade field 430.

The pricing field 440 stores pricing information for the specific contents. For example, pricing information for the contents using period and numbers are stored in the pricing field 440. The file field 450 stores the content files (i.e., execution files).

FIG. 4 shows an example of the database structure for managing the package content in the package content providing server of FIG. 2.

Referring to FIGS. 2 and 4, the package content management DB 300 contained in the package content providing server 200 includes a packaged content ID field 310, a package content name field 320, and a content list field 330.

The content list field 330 stores individual packaged contents Ids 331, 332 and 333 of the individual packaged contents of the content package. At this point, the individual packaged content Ids stored in the content list 330 corresponds to the respective individual content Ids stored in the content ID field 410 of FIG. 3.

FIG. 5 shows an example of the database structure for managing contents purchase history information in the package content providing server of FIG. 2. Here, the contents purchase history information is formed for each user.

Referring to FIGS. 2 and 5, the contents purchase history information management DB 500 contained in the DRM-based package content providing server 200 includes a user ID field 510, a contents ID field 520, a contents type field 530, a usable period field 540, and a usable number field 550.

The contents ID field 520 stores Ids of the contents purchased by the user. When the user purchases an individual content, the content ID field 520 stored a content ID corresponding to the purchased individual content. When the user purchases a package content having one or more individual contents, the content ID field 520 stores the package content ID.

The content type field 530 stores the content type purchased by the user. For example, the content type field 530 stores information for identifying if the content purchased by the user is the individual content or the content package.

The usable period field 540 the usable number field 550 stored information on the usable period and the usable number.

FIG. 6 shows a data format for the package content transmitted from the package content providing server according to one embodiment of the present invention to the user terminal. FIG. 6 shows an example where a n-number of individual contents is contained in the content package.

Referring to FIGS. 2 and 6, the data format 600 for the package content generated at the content transmitting information generation unit 260 and transmitted to the user terminal through the communication I/F unit 230 includes a package content ID 610, a package right object 620, and a content ID 1 630/coded content 1 640 to a content ID n 670/coded content n 680. When the user authentication is performed, only one package right object is used for all of the individual contents contained the content package.

User terminal ID information to which the data format will be transmitted is omitted in the data format 600. However, in one embodiment, the user terminal identification information is contained in the data format 600. In this case, when the data purchase order is inputted from a specific user terminal through the communication I/F unit 230, the control unit 240 detects the terminal ID from user information contained in the purchase order and provides the detected terminal ID to the content transmitting information generation unit 260.

FIGS. 3 through 6 are exemplary only but the present invention is not limited to these examples. For example, the individual content management DB 400 of FIG. 3 may further include a description field storing a brief description on the contents.

Meanwhile, a terminal for processing the package content provided from the content providing server will now described.

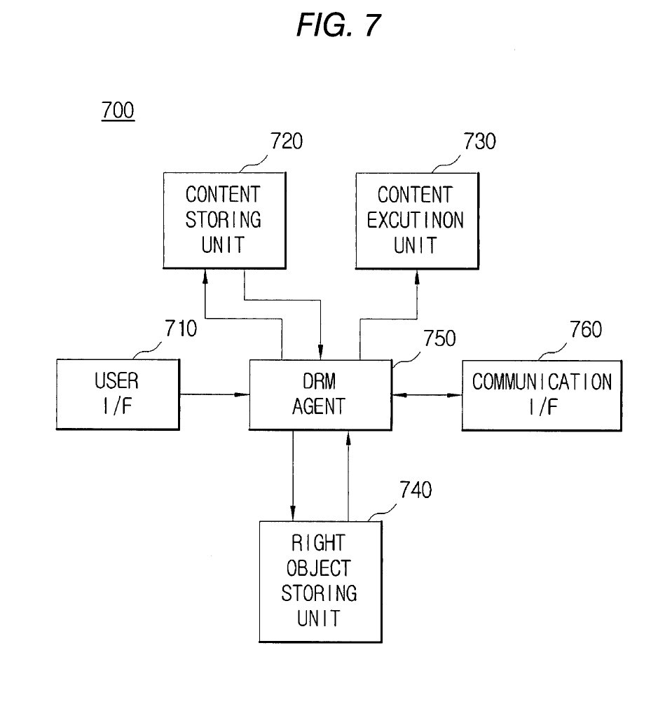

FIG. 7 is a schematic block diagram of a package content processing terminal according to an embodiment of the present invention.

Referring to FIG. 7, a package content processing terminal of a present embodiment includes a user I/F 710, a contents storing unit 710, a content execution unit 730, a user right object storing unit 740, a DRM agent 750, and a communication I/F 760.

The user I/F 710 provides an interface with the user. For example, the user I/F 710 receives a package content purchase order from the user and transmits the order to the DRM agent 750.

The communication I/F 760 provides an interface with the communication network. For example, the communication I/F 760 receives the content transmitting information in response to the user's order from the package content providing server (see 200 of FIG. 2) and transmits the information to the DRM agent 750.

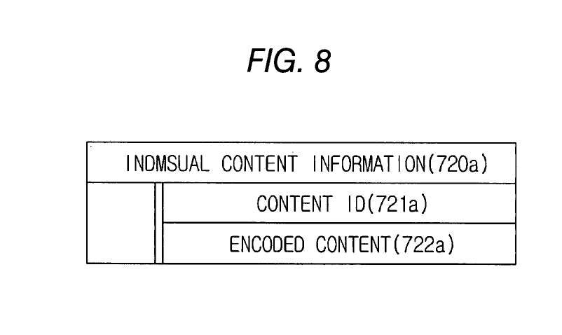

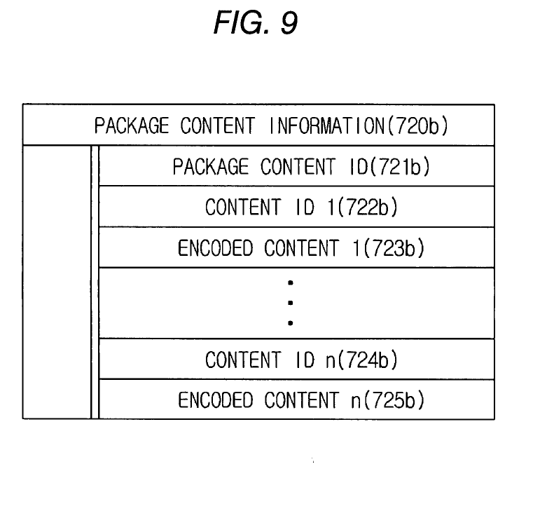

The contents storing unit 720 stores the content information transmitted from the content providing server. For example, the contents storing unit 720 receives the content transmitting information corresponding to the package content from the DRM-based package content providing server (see 200 of FIG. 2) and stores the package right object. To achieve this, the DRM agent 750 detects the right object information from the content transmitting information transmitted through the communication I/F 760 and transmits the detected result to the right object storing unit 740. For example, when the content transmitting information received through the communication I/F 760 is for the content package, the DRM agent 750 detects the package right object and transmits the detected package right object to the right object storing unit 740. A DB structure for storing the right object information in the right object storing unit 740 is exampled in FIGS. 8 and 9. Therefore, DB structures stored in the right object storing unit 740 for the individual content information and the package content information will now be described with reference to FIGS. 8 and 9.

The DRM agent 750 performs a process for executing the DRM-based digital contents. For example, when the user requests the execution of a content, the DRM agent determines if the requested content is contained in the package content he/she purchased. When it is determined that the requested content is contained in the content package, the DRM agent decodes the requested content using the package right object stored in the right object storing unit 740. When it is determined that the requested content is not contained in the content package, the DRM agent decodes the requested content using the individual right object stored in the right object storing unit 740.

As described above, according to one embodiment of the present invention, only one package right object is used for all of the contents contained in the content package. That is, even when many contents are contained in the content package, it is sufficient to store only one package right object. Therefore, the memory use efficiency can be improved. A DB structure for managing the content information and right object information in the package content processing terminal will now be described.

FIGS. 8 and 9 shows examples of DB structures for managing content information stored in the package content processing terminal according to one embodiment of the present invention. FIG. 8 shows an example of a content information storing DB 720A for the individual content and FIG. 9 shows an example of a content information storing DB 720B for the content package.

Referring to FIG. 8, the content information storing DB 720a for the individual content includes a content ID field 721a and an encoded content field 722a. The content ID field 721a stores information for identifying the content. The content ID is used as information connected to the separately stored right object information.

Referring to FIG. 9, the content information storing DB 720b for the package content includes a package content ID field 721b, and a content ID_1 field 722b/a coded content_1 723b to a content ID_n 724b/a coded content_n 725b. The content_ID fields 722b and 724b store Ids for identifying the individual contents contained in the content package. The package content ID is used as information connected to the separately stored package right object information.

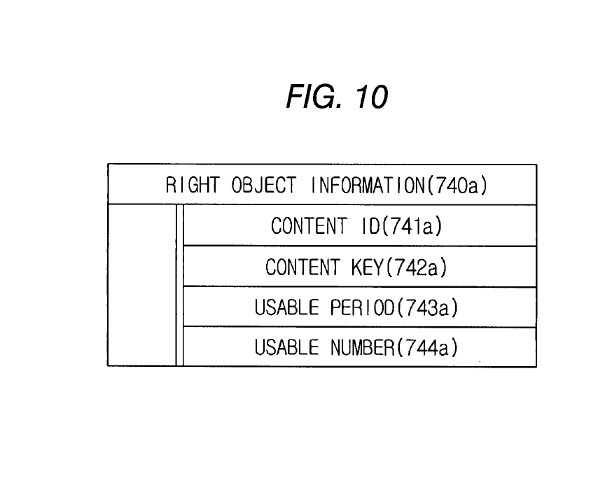

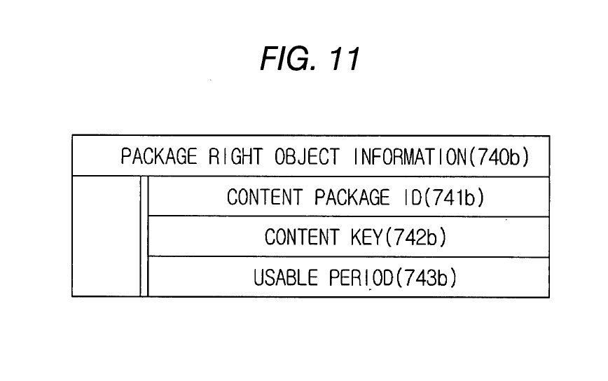

FIGS. 10 and 11 are views of database structures for managing content information stored in the package content processing terminal. FIG. 10 shows an example of a right object information management DB 740a for the individual content and FIG. 11 shows an example of a package right object information management DB 740b for the content package.

Referring to FIG. 10, the right object information management DB 740a includes a content ID field 741a, a content key field 742a, a usable period field 743a, and a usable number field 744a. The content key field 742a stores information (i.e., authentication key) for decoding the encoded content.

Referring to FIG. 11, the package right object information management DB 740b for the package content includes a package content ID field 741b, a content key field 742b, and a usable period field 743b. The content key field 742b stores information for decoding one or more contents contained in the content package. In addition, the package right object information management DB 740b may further include a usable number field (not shown).

A method for providing the package content and a method for processing the provided package content of the package content providing server and terminal of the foregoing embodiments will now be described with reference to the accompanying drawings.

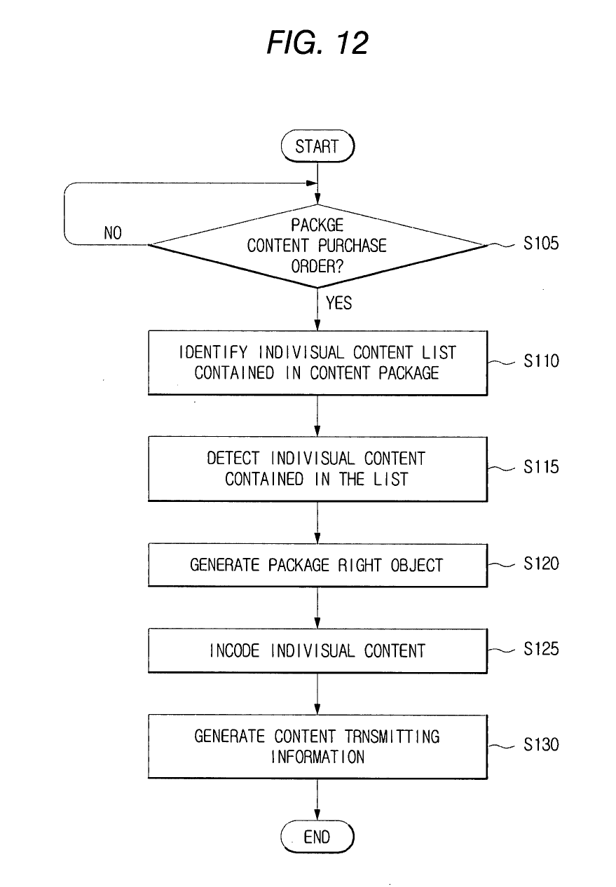

FIG. 12 is a flowchart of a process for processing the package content in the package content providing server according to an embodiment of the present invention.

Referring to FIG. 12, the operation of the package content provided server (hereinafter, referred as “server”) will now be described.

First, when the user orders the package content using the user terminal (S105), the server searches the package content information with reference to the package content ID contained in the order and identifies the individual content list contained in the package content with reference to the package content information (S110). At this point, the package content information may have the structure of FIG. 4.

Then, the server search the individual contents contained in the list (S115). For example, the server searches the individual content management DB for the individual contents using the content Ids contained in the content list. At this point, the individual content management DB may have the structure of FIG. 3.

Next, the server generates a package right object that can be commonly used for all of the searched individual contents (S120) and encodes all of the individual contents (S125).

Then, the server generates content transmitting information containing the generated package right object and the encoded individual contents (S130) and transmits the content transmitting information to the user terminal. At this point, the generated content transmitting information may have the structure of FIG. 6.

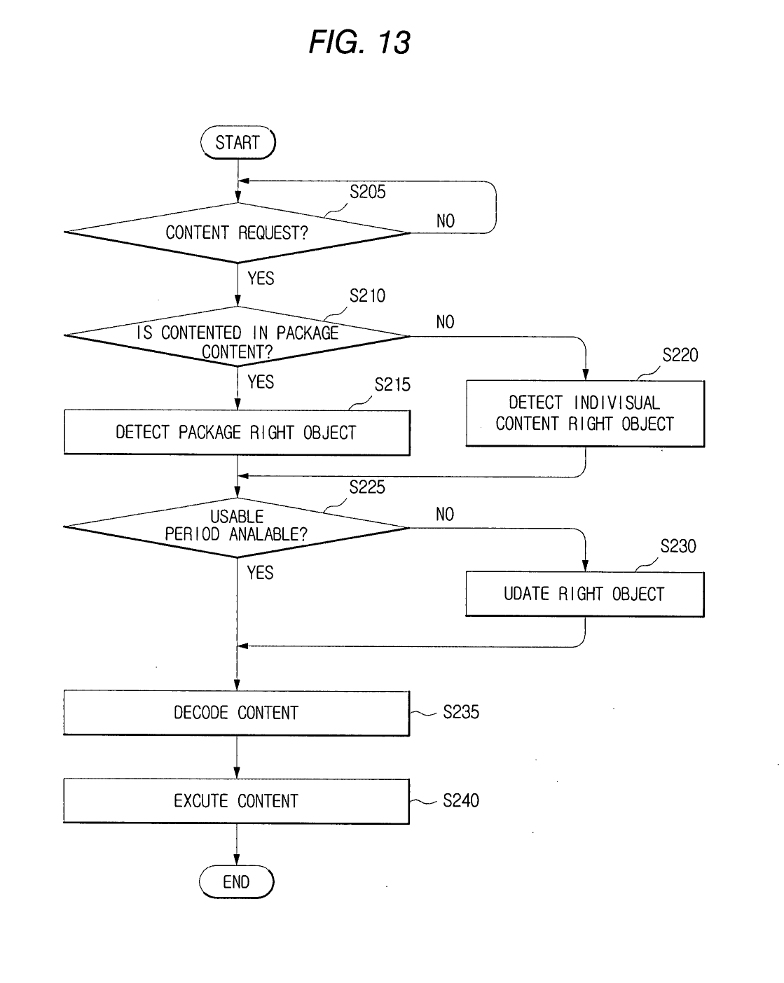

FIG. 13 is a flowchart of a process for processing the package content in the package content processing terminal according to an embodiment of the present invention.

Referring to FIG. 13, the operation of the package content processing terminal (hereinafter, referred as “terminal”) will now be described.

When the user requests the execution of one of the stored contents (S205), the terminal identifies if the requested content is contained in the package content (S210). To achieve this, the terminal identifies the package list contained in the package content from the package content information stored in the content information storing unit and further identifies if the requested content is contained in the package list.

When it is identified that the requested content is contained in the content package, the package right object is detected from the right object information stored in the terminal (S215). When it is identified that the requested content is not contained in the content package, the individual right object is detected from the individual right object information stored in the terminal (S220).

Next, it is determined if the detected usable period is available (S225). When it is determined that the usable period is available, the requested content S235 is decoded using the detected right object and the requested content is executed (S240).

When the usable period is not available, the right object is updated (S230). To achieve this, the terminal pays money for the package content by connecting to the seller of the content package.

In the foregoing embodiment, the DRM-based package content providing and processing apparatus and method are described. In the following embodiment, a DRM-based period-based flat rate service content period-based flat rate contents providing and processing apparatus and method will be described.

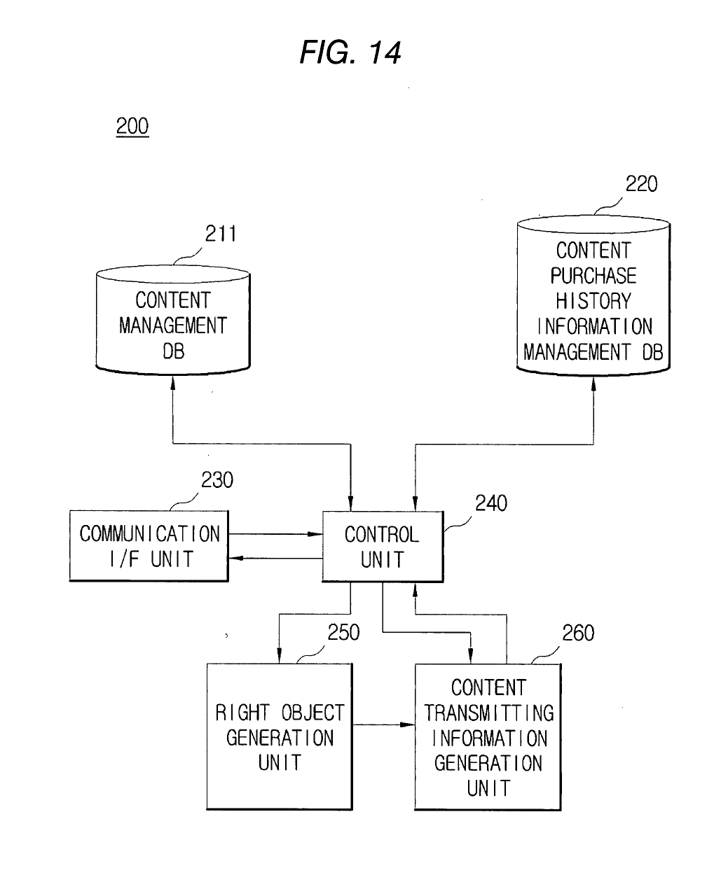

FIG. 14 is a schematic block diagram of a DRM-based period-based flat rate service content period-based flat rate contents providing server according to an embodiment of the present invention.

Likewise the embodiment of FIG. 2, referring to FIG. 14, the DRM-based period-based flat rate service content period-based flat rate contents providing server 200 includes a contents management database (DB) 210, a content purchase history information management DB 220, a communication interface (I/F) unit 230, a control unit 240, a right object generation unit 250, and a content transmitting information generation unit 260. The DRM-based based-based flat rate service contents providing server 200 further includes a user management DB 270.

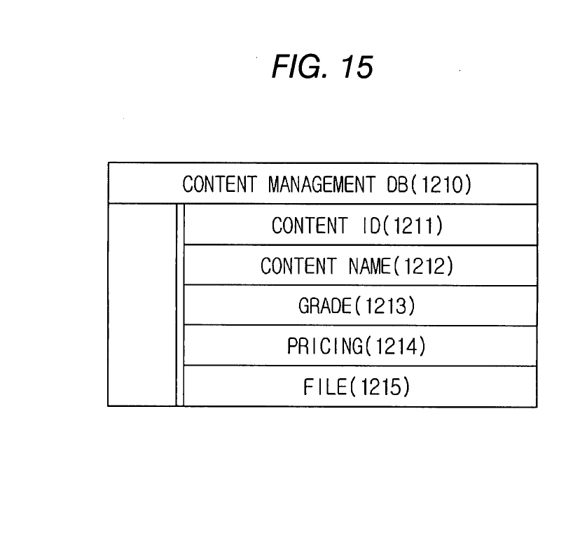

The contents management DB 210 manages information of all of the contents. As shown in FIG. 15, the contents management DB includes a content ID field 1211, a content name field 1212, a grade fields 1213, a pricing field 1214, and a file field 1215. The contents management DB may manage the information of each content. Particularly,

The grade field 1213 stores grade information for limiting the users for specific contents. For example, when it is intended to limit the age of the users for the specific contents under 19, a value “19” is stored in the grade field 430 and when it is intended to limit the age of the users for the specific contents under 15, a value “15” is stored in the grade field 1213. The pricing field 1214 stores pricing information for the specific contents. For example, pricing information for the contents using period and numbers are stored in the pricing field 1214. The file field 1215 stores the content files (i.e., execution files).

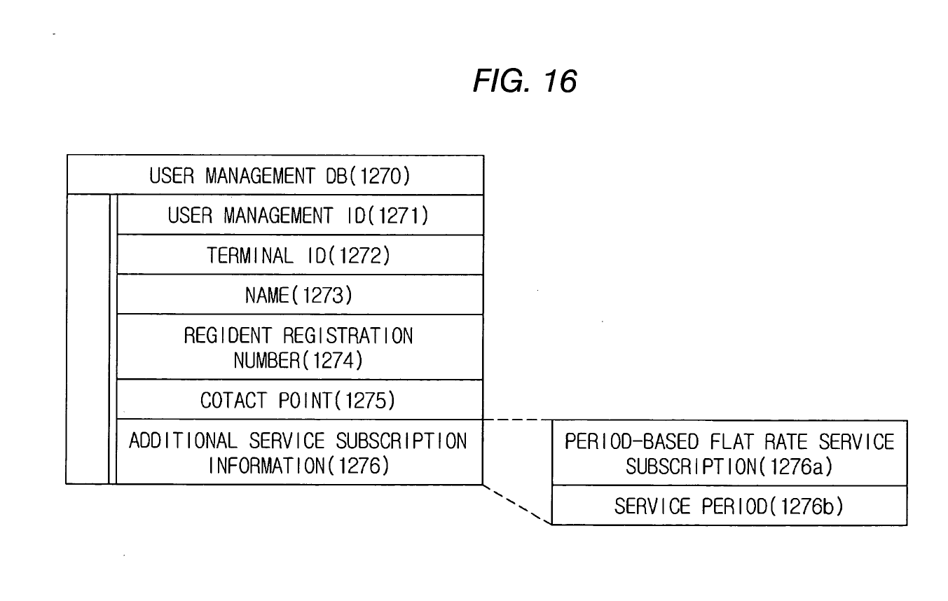

The user management DB 270 manages the users who have been purchased the contents provided from the server 200. A user management DB format 1270, as shown in FIG. 16, includes a user ID field 1271, a terminal ID field 1272, a user name field 1273, a user resident registration No. field 1274, a user contact field 1275, and a premium additional service registration information field 1276. The premium additional service registration information field 1276 includes a field 1276a for storing information on if the user subscribes the premium additional service and a field 1276b for storing information on a service period for the premium additional service of the user.

The communication I/F unit 230 provides an interface with the user terminals through the communication network. For example, when the period-based flat rate service content period-based flat rate contents purchase order is inputted from the user terminal, the communication I/F unit 230 transmits the order to the control unit 240, receives a masker right object generated kin response to the order from the control unit 240, and transmits the master right object to the user terminal.

The control unit 240 searches the contents management DB 210 for contents information corresponding to the user's order information inputted through the communication I/F unit 230 and controls the right object generation unit 250 and the content transmitting information generation unit 260 to generate digital content transmitting information corresponding to the purchase order. For example, when the user subscribing the period-based flat rate content plan service orders a specific content, the control unit 240 searches the user management DB 270 to identify the service period for the user. That is, when the service period expires, the right object generation unit 250 controlled to update the master right object. When the service period does not expire, the content transmitting information generation unit 260 is controlled to generate information for transmitting the ordered content to the user.

The right object generation unit 250 is controlled by the control unit 240 to generate the right objects for the ordered digital content. For example, when the user subscribing the period-based flat rate service orders a specific content, the right object generation unit 250 generates the right object corresponding the specific content. In addition, when the service period for the user expires, the right object generation unit 250 updates the master right object and transmits the result to the content transmitting information generation unit 260.

The content transmitting information generation unit 260 is controlled by the control unit 240 to generate information for transmitting the ordered content to the user terminal. For example, the content transmitting information generation unit 260 receives the ordered digital content search result through the control unit 240 and the right object for the digital content from the right object generation unit 250 and generates a content transmitting information that will be transmitted to the user terminal.

Especially, when the user subscribing the period-based flat rate service requests execution of a specific content, the content transmitting information generation unit 260 receives the digital content search result requested by the user through the control unit 240 as well as the individual right object for the content from the right object generation unit 250. Then, the individual right object and the digital content are encoded to generate the content transmitting information.

Meanwhile, when the master right object is transmitted from the right object generation unit 250 to the content transmitting information generation unit 260, the content transmitting information generation unit 260 generates information for transmitting the master right object to the user terminal.

A terminal for processing the period-based flat rate service content period-based flat rate contents will be described again with reference to FIG. 7.

Referring to FIG. 7, a period-based flat rate service content period-based flat rate content processing terminal 700 of the present embodiment includes a user I/F 710, a contents storing unit 710, a content execution unit 730, a user right object storing unit 740, a DRM agent 750, and a communication I/F 760.

The user I/F 710 provides an interface with the user. For example, the user I/F 710 receives a period-based flat rate service content period-based flat rate content purchase order from the user and transmits the order to the DRM agent 750.

The communication I/F 760 provides an interface with the communication network. For example, the communication I/F 760 receives the content transmitting information in response to the user's order from the package content providing server (see 200 of FIG. 14) and transmits the information to the DRM agent 750.

The contents storing unit 720 stores the content information transmitted from the content providing server. For example, the contents storing unit 720 receives the content transmitting information corresponding to the period-based flat rate service content period-based flat rate content from the DRM-based period-based flat rate service content period-based flat rate content providing server (see 200 of FIG. 14) and stores the period-based flat rate service content period-based flat rate content information (i.e., encoded individual right object and encoded content).

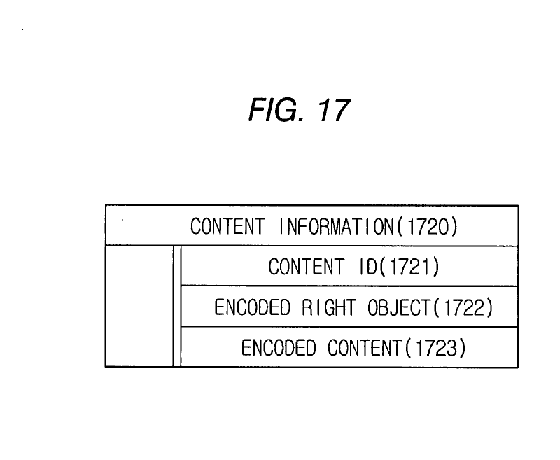

To achieve this, the DRM agent 750 detects information, which will be stored in the content storing unit 720, from the content transmitting information transmitted through the communication I/F 760 and transmits the information to the content storing unit 720. For example, when the content transmitting information received through the communication I/F 760 is for the period-based flat rate service content period-based flat rate content, the DRM agent 750 detects information (i.e., coded individual right object and coded content) except for the master right object and transmits the same to the content storing unit 720. A DB structure for storing the period-based flat rate service content period-based flat rate content in the content storing unit 720 is exampled in FIG. 17. A DB structure for storing the period-based flat rate service content period-based flat rate content in the content storing unit 720 will be described with reference to FIG. 17.

The content execution unit 730 executes the content requested by the user according to the control of the DRM agent 750. That is, the content execution unit 730 executes the content decoded by the DRM agent 750.

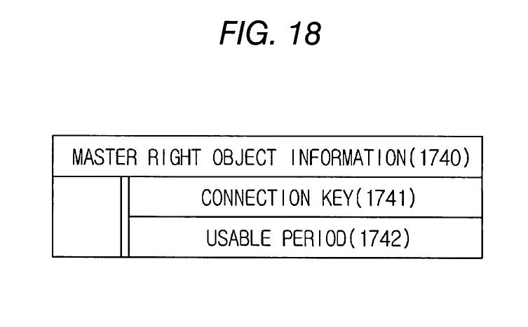

The right object storing unit 740 stores the right object information transmitted from the DRM-based period-based flat rate service content period-based flat rate content providing server (200 of FIG. 14). For example, when the master right object is transmitted from the DRM-based period-based flat rate service content period-based flat rate content providing server 200, the right object storing unit 740 stores the master right object information. When the individual right object for the specific content is transmitted, the right object storing unit 740 stores the individual right object. A DB structure for storing the right object information in the right object storing unit 740 is exampled in FIG. 18 and will now be described.

The DRM agent 750 performs a process for executing the DRM-based digital contents. For example, when the user subscribing the period-based flat rate service content period-based flat rate content service requests the execution of a specific content, the DRM agent 750 transmits the requesting message to the server (200 of FIG. 14) and, when the content information is transmitted from the server, stores the content information. Then, the DRM agent 750 detects the right object information (i.e., master object right) from the right object storing unit 740 and decodes the content information. Then, the DRM agent 750 controls the content execution unit 730 using the decoded result such that the content execution unit 730 executes the specific content.

FIG. 17 is a view of a database structure for managing period-based flat rate service content period-based flat rate contents information transferred from the content providing server to a user terminal according to another embodiment of the present invention and FIG. 18 is a view of a database structure for managing master right object information transferred from the content providing server to a user terminal according to another embodiment of the present invention.

Referring to FIG. 17, the content information management DB 720a includes a content ID field 721a, an encoded right object field 722a, and an encoded content field 723a. For the period-based flat rate service content period-based flat rate content, an encoded right object is stored in the content storing unit.

Referring to FIG. 18, the master right object information management DB 340a includes a connecting key field 341a and a usable period field 341b. The connection key field 341a stores information for decoding the encoded right object (i.e., individual right object) contained in the period-based flat rate content information. For example, the connection key field 341a stores information for decoding the information stored in the encoded right object field 722a of FIG. 17.

A method for providing and processing the period-based flat rate service content period-based flat rate content between the DRM-based period-based flat rate service content period-based flat rate content providing server (hereinafter, referred as “server”) and the DRM-based period-based flat rate service content period-based flat rate content processing terminal will now be described.

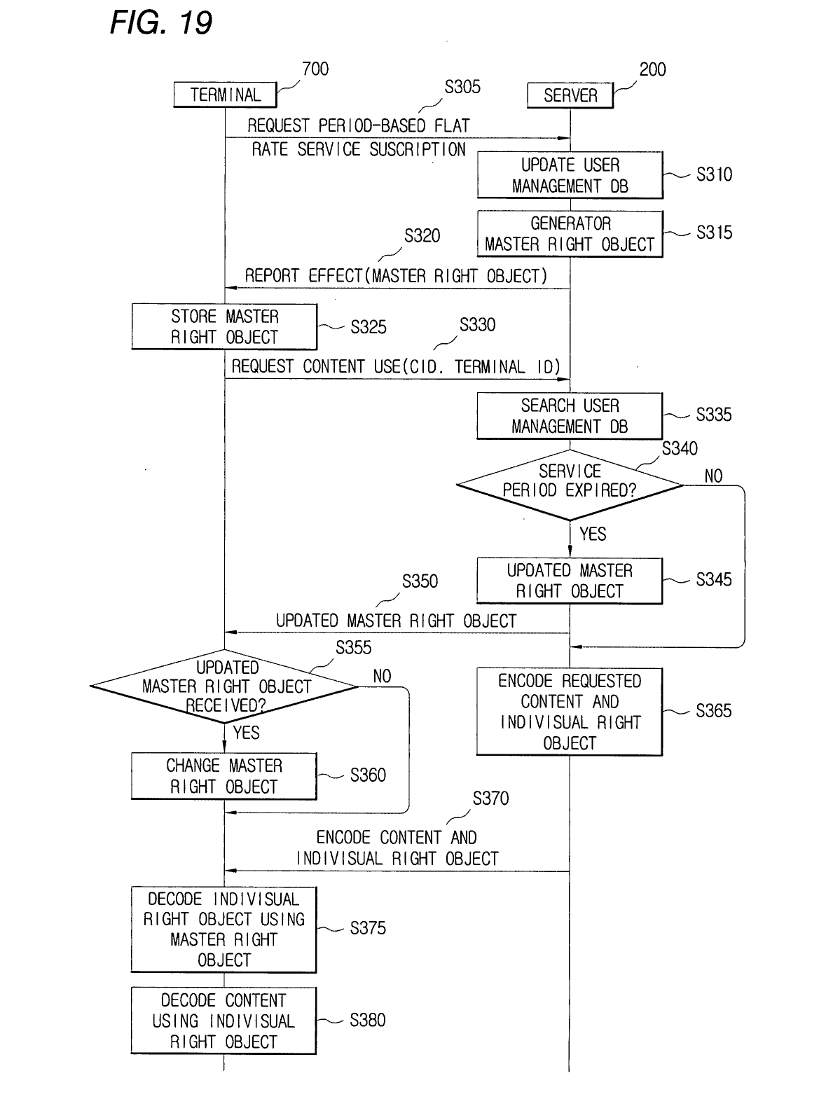

FIG. 19 is a flowchart of a DRM-based period-based plan contents providing and processing method according to an embodiment of the present invention.

Referring to FIG. 19, when the user terminal 700 transmits a subscription request message for the period-based flat rate service content period-based flat rate content service to the server 200 (S305), the server 200 updates the user management DB stored in the terminal 700 (S310).

For example, the premium additional service subscription information contained in the user management DB is updated. That is, a description (i.e., Flag mark) for the use of the period-based flat rate service by the user and the service period are recorded in the premium additional service subscription field of the user management field.

In addition, the server 200 generates the master right object so that the user of the user terminal 700 can use all of the contents provided from the server 200 for the service period (S315) and transmits the master right object to the user terminal 700 (S320). At this point, Step S320 may be performed together with the results report in response to the request of Step S305.

Then, the terminal 700 receiving the master right object stores the master right object in the memory (S325).

In addition, the terminal 700 transmits the content use request message to the server 200 according to the user content selection information (S350). At this point, the terminal 700 may transmits a content ID, which will be requested together with the content use request message, and a terminal ID.

Then, the server 200 receiving the content use request message searches the user management DB of the server 200 using the terminal ID (S335). That is, the server 200 identifies if the user subscribes the period-based flat rate service by searching the user management DB.

When it is identified that the user subscribes the period-based flat rate service, the server 200 determines if the service period for the user expires according to the information stored in the user management DB (S340). When it is determined that the service period expires, the master right object provided to the terminal 700 is updated (S345). At this point, the terminal 700 determines the service extension period in response to the user's approval and updates the master right object according to the service extension period.

Then, the server 200 transmits the master right object to the terminal 700 (S350).

Next, the server 200 detects the requested content from the content management DB stored therein, generates the individual right object corresponding to the detected content, and encodes the content and the individual right object (S365). In addition, the encoded content and individual right object are transmitted to the terminal 700.

Meanwhile, when the terminal 700 receives the updated master right object from the server 200 (S355), the terminal updates the stored master right object (S360). Then, when the encoded content and individual right object are transmitted from the server 200 to the terminal 700 (S370), the content execution is performed. That is, the terminal 700 decodes the individual right object using the stored maser right object (S375). Then, the terminal 700 decodes the content using the decoded individual right object (S380) and the terminal 700 executes the content.

As described above, the server assigns the terminal of the user subscribing the period-based flat rate service with the master right object and authenticates the use of the contents for the service period. That is, the encoded individual right object is decoded using the master right object and the encoded content is decoded using the decoded right object.

That is, when the service period is managed using the master right object assigned to the period-based flat rate service content period-based flat rate content, the period-based flat rate service content period-based flat rate content processing terminal 300 can execute one or more contents of the period-based flat rate service without updating right object for each content.

In the foregoing embodiment, the DRM-based package content providing and processing apparatus and method are described. In the following embodiment, a DRM-based period-based flat rate service content period-based flat rate contents providing and processing apparatus and method will be described. According to at least one embodiment of the present invention, for the content package, one or more individual contents are detected and a single right object for all of the individual contents of the package content is generated. Then, the individual contents are encoded and content transmitting information containing the encoded individual contents and the package right object is generated and transmitted to the terminal. In the terminal, the package content is decoded and executed. Accordingly, the memory use efficiency is improved and the load of the package content providing server can be reduced.

For the period-based flat rate service content period-based flat rate contents, the content providing server updates the user management DB and generates a master right object for allowing the user to use all of the contents for the service period. The master right is transmitted to the user terminal. When the user request the use of the content, it is determined if the user subscribes the service by searching the user management DB to update the master right object. That is, an effect for extending the service period for all of the period-based flat rate service content period-based flat rate contents can be obtained and thus the user can more conveniently used the period-based flat rate service content period-based flat rate contents.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A digital rights management (DRM)-based package content providing method comprising:
detecting one or more individual contents contained in a content package in response to the content package purchase order received from a user terminal;
generating a package right object that can be commonly used for all of the detected individual contents;
encoding each of the individual contents; and
generating and transmitting content transmitting information containing the encoded individual contents and the package right object to the user terminal.

2. The method of claim 1, wherein the detecting comprises:
detecting the package content package ordered;
identifying an individual content list contained in the content package; and
detecting the one or more individual contents contained in the individual content list.

3. The method of claim 1, wherein the package right object includes key information that can be commonly used for decoding the encoded individual contents contained in the content package; and a usable period of the content package.

4. A digital rights management (DRM)-based package content processing method comprising:
receiving content transmitting information of a content package containing encoded individual contents and a package right object that can be used for all of the individual contents;
decoding one of the individual contents contained in the content transmitting information, which is requested to be executed, using the package right object; and
executing the decoded individual content.

5. The method of claim 4, further comprising identifying if the individual content that is requested to be executed is contained in the content package.

6. A digital rights management (DRM)-based content providing method comprising:
updating a user management database (DB) in response to a period-based flat rate service subscription request received from a user terminal;
generating and providing a master right object allowing a user to use all of the contents for the service period to the user terminal;
determining if the user subscribes the period-based flat rate service by searching the user management DB in response to a content use request received from the user terminal;
encoding, when it is determined that the user subscribes the period-based flat rate service, a period-based flat rate content requested by the user and an individual right object for the content requested by the user; and
transmitting content transmitting information containing the encoded period-based flat rate content and individual right object.

7. The method of claim 6, wherein, when it is determined that the user subscribes the period-based flat rate service, the method further comprises:
determining if the service period for the user expires; and
updating the master right object when it is determined that the service period expires.

8. A digital rights management (DRM)-based content processing method comprising:
requesting a period-based flat rate service content;
receiving content transmitting information containing the requested period-based flat rate service content, which is encoded in response to the requesting of the period-based flat rate service content, and an individual right object from a content providing server;
decoding the encoded individual right object using a master right object received from the content providing server and stored in advance; and
decoding the encoded individual content using the decoded individual right object.

9. The method of claim 8, further comprising:
requesting a period-based flat rate service subscription; and
receiving and storing the master right object generated that is generated in the content providing server in response to the requesting of the period-based flat rate service subscription.

10. The method of claim 9, wherein, when the period-based flat rate service expires, the method further comprises changing the stored master right object by receiving an updated master right object from the content providing server.

11. The method of claim 8, wherein the user management DB records information on whether the user subscribes the period-based flat rate service and information of the service period in an a premium additional service subscription field.

12. The method of claim 10, wherein the master right object includes key information for decoding each of one or more of the individual contents contained in one or more of the period-based flat rate service contents and a usable period of the period-based flat rate service contents.

13. A digital rights management (DRM)-based content providing apparatus comprising:
a content management database (DB) unit configured to store information on a content package and one or more individual contents contained in the content package;
a control unit configured to detect the one or more individual contents contained in the content package from the content management DB in response to a content purchase of the content package order received from a user terminal;
a right object generation unit configured to generate a package right object that can be commonly used for the individual contents detected by the control unit; and
a content transmitting information generation unit configured to
i) encode the individual contents detected by the control unit,
ii) generate content transmitting information of the content package containing the package right object, and
iii) transmit the content transmitting information to the user terminal.

14. The DRM-based content providing apparatus of claim 13, wherein the control unit is further configured to
i) detect the package content that is ordered from the user terminal,
ii) identify an individual content list contained in the content package, and
iii) detect one or more individual contents contained in the individual content list.

15. The DRM-based content providing apparatus of claim 13, wherein the package right object comprises key information that can be commonly used for decoding the encoded individual contents contained in the content package; and a usable period of the content package.

16. A digital rights management (DRM)-based content processing apparatus comprising:
a communication interface unit configured to receive content transmitting information containing one or more encoded individual contents and a package right object that can be commonly used for all of the individual contents;
a content storing unit configured to detect the encoded individual contents from the content transmitting information and store the detected contents therein;
a right object storing unit configured to detect the encoded package right object for decoding the encoded individual contents from the content transmitting information and store the detected right object therein; and
a DRM agent configured to decode one of the individual contents, which is requested to be executed, contained in the content package.

17. The DRM-based content processing apparatus of claim 16, wherein the content storing unit comprises a content package management database having a package content ID, IDs of one or more individual contents contained in the content package, and encoded content information.

18. The DRM-based content processing apparatus of claim 16, wherein the DRM agent is further configured to search the content storing unit in response to the individual content execution request by the user, identifies if the requested individual content is contained in the content package, and decodes the individual content using the package right object when the individual content is contained in the content package.

19. The DRM-based content processing apparatus of claim 16, wherein the right object storing unit comprises a user right object management database having a content package ID and key information that is commonly used for decoding all of the contents contained in the content package.

20. A digital rights management (DRM)-based content providing apparatus comprising:
a content management database configured to store information on a period-based flat rate service content period-based flat rate contents;
a user management database configured to store information on users who receive the period-based flat rate service content period-based flat rate contents;
a master right object generation unit configured to generate a master right object allowing the user to use all of the contents provided from the server for a predetermined service period in response to subscription request information of the user; and
a communication interface unit configured to transmit to the user the master right object.

21. The DRM-based content providing apparatus of claim 20, wherein the right object generation unit identifies if the service period expires when the user subscribing the period-based flat rate service requests the content and updates the master right object when it is identified that the service period for the user expires.

22. The DRM-based content providing apparatus of claim 20, wherein the user management database comprises an additional premium service subscription information field of the user, the additional premium service subscription information field comprising:
a field configured to identify if the user subscribes identifies the period-based flat rate service; and
a filed configured to store a period for the period-based flat rate service.

23. The DRM-based content providing apparatus of claim 20, wherein the master right object comprises:
key information configured to decode individual right objects for all of the contents that can be provided for the service period; and
a usable period of the period-based flat rate service content period-based flat rate contents.

24. A digital rights management (DRM)-based content processing apparatus comprising:
a master right object storing unit configured to receive and store a master right object from a content providing server in response to a subscription request of a user;
a content information storing unit configured to receive and store encoded contents and encoded individual right objects from the content providing server in response to a content use request of the user; and
a DRM agent configured to authenticate if the execution of the requested content is possible using a master right object in response to the content use request of the user.

25. The DRM-based content processing apparatus of claim 24, wherein the DRM agent is further configured to decode the encoded individual right object of the requested content using the master right object and decode the encoded content using the decoded individual right object.

26. The DRM-based content processing apparatus of claim 24, wherein the right object storing unit comprises key information configured to decode individual right objects for all of the contents that can be provided for the service period; and a usable period of the period-based flat rate service content period-based flat rate contents.

27. The DRM-based content processing apparatus of claim 24, wherein the content storing unit comprises a field configured to store content IDs, a field configured to store encoded individual right objects for respective contents, and a field for encoded contents.
